(19) United States
(12) Patent Application Publication
(10) Pub. No.: US 2026/0162170 A1
(43) Pub. Date: Jun. 11, 2026

(54) INTERACTIVE PROPOSAL OUTPUT SYSTEM

(71) Applicant: YAMAHA HATSUDOKI KABUSHIKI KAISHA, Iwata-shi (JP)

(72) Inventors: Ikuma TOCHIHIRA, Shizuoka (JP); Takahiro FUJII, Shizuoka (JP); Kazuya HIEDA, Shizuoka (JP)

(21) Appl. No.: 19/183,410

(22) Filed: Apr. 18, 2025

Related U.S. Application Data
(63) Continuation-in-part of application No. PCT/JP2023/037729, filed on Oct. 18, 2023.

(30) Foreign Application Priority Data
Oct. 21, 2022 (WO) PCT/JP2022/039323

(51) Int. Cl. G06Q 30/0601

(52) U.S. Cl. CPC G06Q 30/06312

(57) ABSTRACT

A system for generating a recommendation to a first user based on an evaluation structure for a plurality of users including the first user and a second user, the evaluation structure including a lower-tier element, a middle-tier element and an upper-tier element. The system includes: an input section, a model, and an output section. The input section receives at least intermediate-tier data inputted by each user, the intermediate-tier data relating to the middle-tier element, which is in association with either the lower-tier element or the upper-tier element. The model acquires the intermediate-tier data on each of the plurality of users, and generates recommendation data based on the acquired intermediate-tier data, such that as the acquired intermediate-tier data of the first user changes, the recommendation data changes, or even if the acquired intermediate-tier data of the first user is unchanged, the recommendation data changes.

### CROSS-REFERENCE TO RELATED APPLICATIONS

This is a continuation-in-part application of International Application PCT/JP2023/037729, filed on Oct. 18, 2023, which claims priority from International Application PCT/JP2022/039323, filed on Oct. 21, 2022. The contents of the applications are incorporated herein by reference.

### TECHNICAL FIELD

The present teaching relates to an interactive proposal output system.

### BACKGROUND ART

Conventionally known is a recommendation system. An algorithm used in a general recommendation system is broadly classified into two, namely, content-based filtering and collaborative filtering.

By the content-based filtering, an item evaluation model of a user is obtained through, for example, learning from data on a user's preference rating and a characteristic (such as a genre) of an item, and the obtained item evaluation model is used to propose an item. By the collaborative filtering, another user whose preferences are similar to those of a target user is found based on the user's preference rating, and an item that is evaluated by the other user having the similar preferences is proposed. A recommendation system that uses another user's preference information is disclosed in, for example, Japanese Patent Application Laid-Open No. 2018-5918.

### CITATION LIST

### Patent Literature

PTL 1: Japanese Patent Application Laid-Open No. 2018-5918

### SUMMARY OF INVENTION

### Technical Problem

In the content-based filtering, the item evaluation model of the user is built based on evaluations of items that have been used by the user so far. Thus, an output from the item evaluation model is biased, and an object to be proposed is limited.

In the collaborative filtering, an evaluation by another user having similar preferences as those of the target user is used. Thus, an appropriate proposal cannot be given if the number of users other than the target user, which in other words are other users, is small, or if the number of item evaluations made by users is small. That is, the accuracy of a proposal is lowered. Moreover, in order that the collaborative filtering can give a proposal with both a diversity and an accuracy, a large and a varied amount of data is required.

The present teaching aims to provide a system capable of reducing a processing load while achieving both the accuracy and diversity of a proposal, to consequently allow downsizing of hardware resources.

### Solution to the Problem

Focusing on a point of view of achieving both the accuracy and diversity of a proposal, the inventors of the present teaching conducted studies on an interactive proposal output system, which means a recommendation system that gives a proposal in response to a user's input, from a technical perspective of downsizing hardware resources. To be specific, an item evaluation made by a user was studied from a technical perspective of allowing downsizing of hardware resources. As a result, the following knowledge was obtained.

There is a wide variety of item evaluations made by users. Even though evaluations on one item are the same, the one item may be evaluated from different perspectives. For example, there may be a case in which one user evaluates a certain characteristic of the one item while another user different from the one user evaluates another characteristic different from the certain characteristic.

With reference to such item evaluations made by users, the inventors of the present teaching examined data to be provided from users in the interactive proposal output system from a technical perspective of allowing downsizing of hardware resources, in order to achieve both the accuracy and diversity of a proposal. As a result, the following knowledge was obtained.

For example, in a case of a plurality of elements in a hierarchical relationship, it is just required that for each combination of adjacent two-tiers, data that associates elements belonging respectively to the adjacent two-tiers be present. For example, data that associates a lower-tier element belonging to a lower-tier with a middle-tier element belonging to a middle-tier, which is higher than the lower-tier, and data that associates the middle-tier element with an upper-tier element belonging to an upper-tier, which is higher than the middle-tier, are required. To put it another way, the middle-tier element is present between the lower-tier element and the upper-tier element, and the middle-tier element is associated with each of the lower-tier element and the upper-tier element. In a case of the three types of elements in such a relationship, namely, the lower-tier element, the middle-tier element, and the upper-tier element; data that associates the lower-tier element with the middle-tier element and data that associates the middle-tier element with the upper-tier element are required. The data that associates the lower-tier element with the middle-tier element may be, for example, data relating to the middle-tier element associated with the lower-tier element. The data that associates the middle-tier element with the upper-tier element may be, for example, data relating to the upper-tier element associated with the middle-tier element. Alternatively, for example, in a case of a plurality of elements in a hierarchical relationship, it is just required that data relating to an element that associates an element belonging to one of adjacent two-tiers with an element belonging to the other of the adjacent two-tiers be present. For example, data relating to the middle-tier element, which is associated with each of the lower and upper-tier elements as mentioned above, is required. The data relating to the middle-tier element includes data that associates the lower-tier element with the middle-tier element, and data that associates the middle-tier element with the upper-tier element, for example. If data having such a relationship is provided by users, both the accuracy and diversity of a proposal can be achieved in the interactive proposal output system. A reduction of a processing load, and consequently downsizing of hardware resources, can be obtained. The present teaching has been accomplished based on this knowledge.
(1) A system according to an embodiment of the present teaching is a system including:
an input section;
a model; and
an output section,
the input section being configured to receive at least intermediate-tier data inputted by each of a plurality of users,
the intermediate-tier data relating to a middle-tier element, which is inputted in association with each of a lower-tier element and an upper-tier element,
the model being configured to acquire the intermediate-tier data on each of the plurality of users, and configured in a way where the intermediate tier data on each of the plurality of users and recommendation data are associated based on the acquired intermediate tier data on each of the plurality of users such that: as the acquired intermediate-tier data on a certain user changes, the recommendation data for giving a recommendation to the certain user changes, or even if the acquired intermediate-tier data on a certain user is unchanged, the recommendation data for giving a recommendation to the certain user changes.

The system of (1) makes it possible to reduce a processing load while achieving both the accuracy and diversity of a proposal. To put it another way, given that the processing load is equal to or similar to a conventional one, both the accuracy and diversity of a proposal can be achieved at a higher level. For more details, see the following.

In the system of (1), the model acquires intermediate-tier data on each of the plurality of users, and based on the acquired intermediate-tier data on each of the plurality of users, associates the intermediate-tier data on each of the plurality of users with recommendation data such that as the acquired intermediate-tier data on a certain user changes, the recommendation data for giving a recommendation to the certain user changes, or even if the acquired intermediate-tier data on a certain user is unchanged, the recommendation data for giving a recommendation to the certain user changes. Here, the intermediate-tier data is data relating to a middle-tier element, which is inputted in association with each of a lower-tier element and an upper-tier element. The intermediate-tier data, for example, includes data that associates the lower-tier element with the middle-tier element, and data that associates the middle-tier element with the upper-tier element. It therefore is possible to propose a lower-tier element to the certain user in a manner according to the relevance of the upper-tier element and the middle-tier element in relation to which the input has been made by the certain user, the lower-tier element being associated with a middle-tier element of another user, the lower-tier element being different from a certain lower-tier element in relation to which the input has been made by the certain user, for example.

The system of (1) makes it possible to give a certain user a proposal in response to an input made by the certain user, and also to have the proposal reflect information provided by another user, for example. It is possible to propose a lower-tier element to a certain user in a manner according to the relevance of the upper-tier element and the middle-tier element in relation to which the input has been made by the certain user, the lower-tier element being associated with a middle-tier element of another user, the lower-tier element being different from a certain lower-tier element in relation to which the input has been made by the certain user, for example.

A proposal can be given with an improved accuracy, because the proposal is able to be given to the certain user in a manner according to the relevance of the upper-tier element and the middle-tier element in relation to which the input has been made by the certain user. Something that the certain user has never experienced before can be proposed, because it is possible to propose to the certain user a lower-tier element associated with a middle-tier element of another user, the lower-tier element being different from the certain lower-tier element in relation to which the input has been made by the certain user. For example, even if the middle-tier element corresponding to the middle-tier data on the certain user is the same as a middle-tier element corresponding to middle-tier data on another user, the lower-tier element associated with the middle-tier element of the certain user may be different from a lower-tier element associated with the middle-tier element of the other user. If such middle-tier data relating to the middle-tier element of the other user is reflected in recommendation data, the lower-tier element that is associated with the middle-tier element of the other user and that is different from the certain lower-tier element in relation to which the input has been made by the certain user is able to be outputted as the recommendation data. Something that the certain user has never experienced before can be proposed. This can provide a fresh discovery to the certain user. The diversity of a proposal is improved.

Thus, both the accuracy and diversity of a proposal can be achieved, because it is possible to propose a lower-tier element to the certain user in a manner according to the relevance of the upper-tier element and the middle-tier element in relation to which the input has been made by the certain user, the lower-tier element being associated with a middle-tier element for another user, the lower-tier element being different from a certain lower-tier element in relation to which the input has been made by the certain user.

Here, the intermediate-tier data is data relating to a middle-tier element, which is inputted in association with each of a lower-tier element and an upper-tier element. The middle-tier element is associated with the lower-tier element, and the upper-tier element is associated with this middle-tier element. The data relating to the middle-tier element includes data that associates the lower-tier element with the middle-tier element, and data that associates the middle-tier element with the upper-tier element, for example. The data that associates the lower-tier element with the middle-tier element and the data that associates the middle-tier element with the upper-tier element are tied to each other to have a paired relationship.

Since such data is provided by the user, and a proposal is given by using the data provided by the user, the amount of data handled can be reduced as compared to using a large and a varied amount of data, for achieving both the accuracy and diversity of the proposal. A processing load can be reduced, to consequently allow downsizing of hardware resources.

Given that the processing load is equal to or similar to a conventional one, both the accuracy and diversity of a proposal can be achieved at a higher level.

Use of the above-described data makes it possible to give a proposal to the certain user by using the relationship of the lower-tier element, the middle-tier element, and the upper-tier element, that is, the relationship in which the lower-tier element and the upper-tier element are associated via the middle-tier element. A proposal according to the relevance of a middle-tier element and a lower-tier element of another user can be given in a manner according to the relevance of the upper-tier element and the middle-tier element in relation to which the input has been made by the certain user.
(2) The system according to (1) includes, for example, the following configuration.

The system is an interactive proposal output system,
the intermediate-tier data includes middle-tier data and upper-tier data, the middle-tier data relating to the middle-tier element, which is inputted in association with the lower-tier element, the upper-tier data relating to the upper-tier element, which is inputted in association with the middle-tier element,
the output section is configured to output output data in a case where the middle-tier data and the upper-tier data for a certain lower-tier element are inputted by a certain user, the output data including the recommendation data obtained through the model in accordance with the input of the middle-tier data and the upper-tier data,
the model is a proposal output generation model configured to, in a case where the middle-tier data and the upper-tier data for a certain lower-tier element are inputted by a certain user, output the recommendation data in accordance with the input of the middle-tier data and the upper-tier data, and
the recommendation data is data relating to a lower-tier element that is different from the certain lower-tier element in relation to which the input has been made by the certain user.
(3) The system according to (2) includes, for example, the following configuration.

The model is configured to, in a case where the middle-tier data and the upper-tier data for a certain lower-tier element are inputted by a certain user, output the recommendation data in accordance with the input of the middle-tier data and the upper-tier data, such that the middle-tier data on another user, who is different from the certain user, is reflected in the recommendation data.
(4) The system according to (2) or (3) includes, for example, the following configuration.

The output data further includes involvement data, and
the involvement data is data for informing the certain user that another user, who is different from the certain user, is involved in selection of the lower-tier element related to the recommendation data.

In the system of (4), the involvement data for informing the certain user that another user is involved in selection of the lower-tier element related to the recommendation data is outputted together with the recommendation data. Informing the certain user that the other user is involved in selection of the lower-tier element related to the recommendation data improves the reliability of the proposal. The certain user, who is given a proposal of a lower-tier element that is different from the certain lower-tier element in relation to which the input has been made by the certain user, can be motivated to try the lower-tier element presented in this proposal. An effective proposal can be given.

The intermediate-tier data is just required to be data relating to a middle-tier element, which is inputted in association with each of a lower-tier element and an upper-tier element. The data relating to the middle-tier element may include data that associates the lower-tier element with the middle-tier element, and data that associates the middle-tier element with the upper-tier element, for example. These pieces of data may be compiled into one.

The expression “associate the intermediate-tier data on each of the plurality of users with recommendation data such that as the acquired intermediate-tier data on a certain user changes, the recommendation data for giving a recommendation to the certain user changes, or even though the acquired intermediate-tier data on a certain user is unchanged, the recommendation data for giving a recommendation to the certain user changes” encompasses “the model being configured such that in a case where the intermediate-tier data is inputted by a certain user, the intermediate-tier data on another user, who is different from the certain user, is reflected in the recommendation data.” The expression “as the acquired intermediate-tier data on a certain user changes, the recommendation data for giving a recommendation to the certain user changes” encompasses results of a phenomenon in which “when the intermediate-tier data is inputted by a certain user, the intermediate-tier data on the certain user is changed.” The expression “even though the acquired intermediate-tier data on a certain user is unchanged, the recommendation data for giving a recommendation to the certain user changes” encompasses results of a phenomenon in which “when the intermediate-tier data is inputted by a certain user, the intermediate-tier data on another user, who is different from the certain user, is changed.”

The input section functions as an input data receiving section for receiving input data including user ID data on each of a plurality of users, for example. The expression “the input section being configured to receive at least intermediate-tier data inputted by each of a plurality of users” encompasses a configuration in which the input section is provided corresponding to each of the plurality of users, for example. How to receive the input data is not particularly limited. Reception of the input data may be performed all at once, or may be performed in several batches.

The input data includes at least intermediate-tier data. The input data includes a plurality of types of data, for example. The input data includes middle-tier data and upper-tier data, for example. The input data may further include user ID data. Reception of the user ID data may be performed only at the first time (for example, only at the time of log-in). The middle-tier data and the upper-tier data may be received after the user ID data is received, for example. In a case of receiving the user ID data only at the first time, for example, middle-tier data and upper-tier data are tied to the user ID data upon reception of an input of the middle-tier data and the upper-tier data. This is equivalent to reception of an input of the user ID data, the middle-tier data, and the upper-tier data.

The intermediate-tier data may include information indicating the relevance of the lower-tier element and the middle-tier element, and information indicating the relevance of the middle-tier element and the upper-tier element, for example. The user ID data is used to identify a user, for example. The middle-tier data may include information indicating the relevance of the lower-tier element and the middle-tier element, for example. The upper-tier data may include information indicating the relevance of the middle-tier element and the upper-tier element, for example.

For example, the lower-tier element, the middle-tier element, and the upper-tier element constitute an evaluation structure for a user's evaluation on an object. For example, there is a cause and effect relationship between adjacent elements in the evaluation structure. For example, there is a cause and effect relationship between the lower-tier element and the middle-tier element, and between the middle-tier element and the upper-tier element. The upper-tier element is a top-level element of the evaluation structure, for example. The middle-tier element is an element that is a cause of the upper-tier element, for example. The lower-tier element is an element that is a cause of the middle-tier element, for example.

The upper-tier element is, for example, a final feeling that a user has on an object, and/or a value of the object comprehensively estimated by the user. Examples of the feeling include being delighted being satisfied, being relieved, being bored, and the like. Examples of the value include good/bad, like/dislike, pleasant/unpleasant, and the like.

The middle-tier element is, for example, a partial evaluation or an impression that the user has when focusing on a certain aspect of the object. Examples of the partial evaluation include powerfulness, smoothness, and the like. Examples of the impression include being refreshing, being retro, being showy, and the like.

The lower-tier element is a perception or cognition that the user has on the object, or a component element of the object. Examples of the perception include being sour, being bitter, being loud, being hot, being red, and the like. Examples of the cognition include being rotten (food), classical music played, and the like. Examples of the component element include materials, the shape, color percentages, RGB values, design parameters, and the like.

The upper-tier elements can be compared to each other between a plurality of users, for example. The upper-tier element may be indicated together with its degree, for example. The degree is represented by a score number, for example.

The middle-tier element indicates an evaluation different from the upper-tier element, for example. The middle-tier element indicates a more detailed evaluation than the upper-tier element, for example. The number of middle-tier elements is larger than the number of upper-tier elements, for example. The middle-tier element may be provided in multiple stages, for example. The expression “the middle-tier element is provided in multiple stages” encompasses a configuration in which, for example, a middle-tier element belongs to each of a plurality of middle-tiers in a hierarchical structure while middle-tier elements each belonging to each of adjacent two middle-tiers are associated with each other. The middle-tier element associated with the upper-tier element may be the same as, or may be different from, the middle-tier element associated with the lower-tier element. In a case of the middle-tier element provided in multiple stages, the middle-tier element associated with the upper-tier element is different from the middle-tier element associated with the lower-tier element. The middle-tier element can be an object for comparison between a plurality of lower-tier elements, for example. The middle-tier element may be indicated together with its degree, for example. The degree is represented by a score number, for example.

The lower-tier element is an element that can be an object to be recommended, for example. The lower-tier element is something (such as characteristics) possessed by an object to be recommended, for example. The lower-tier element may be provided in multiple stages, for example. The expression “the lower-tier element is provided in multiple stages” encompasses a configuration in which, for example, a lower-tier element belongs to each of a plurality of lower-tiers in a hierarchical structure while lower tier elements each belonging to each of adjacent two lower tiers are associated with each other.

The output section outputs output data when user ID data on a certain user, and middle and upper-tier data in relation to a certain lower-tier element are inputted, for example. The output data includes recommendation data. The output data may further include involvement data.

The expression “when user ID data on a certain user, and middle and upper-tier data in relation to a certain lower-tier element are inputted” encompasses a case where user ID data on a certain user, and middle and upper-tier data in relation to a certain lower-tier element are inputted while the user ID data on the certain user is associated with the middle and upper-tier data in relation to the certain lower-tier element, for example. The expression “when user ID data on a certain user, and middle and upper-tier data in relation to a certain lower-tier element are inputted” refers to, for example, a “case where middle-tier data and upper-tier data in relation to a certain lower-tier element are inputted by a certain user.”

The recommendation data is obtained through the model (proposal output generation model) in accordance with the input of the user ID data, the middle-tier data, and the upper-tier data, for example. The recommendation data is data relating to a lower-tier element that is different from the certain lower-tier element in relation to which the input has been made by the certain user, for example.

The expression “the certain lower-tier element in relation to which the input has been made by the certain user” is just required to express a lower-tier element that corresponds to the middle-tier data inputted by the certain user. A timing when the input is made by the certain user is not particularly limited.

The recommendation data is data relating to a lower-tier element, in which the input made by the certain user and an input made by another user are reflected, for example. The input made by the certain user reflected in the recommendation data is not limited to the latest (or the most recent) input. The input made by the certain user reflected in the recommendation data is any of the inputs that have been made so far by the certain user, for example. The input made by the other user reflected in the recommendation data is not limited to the latest (or the most recent) input. The input made by the other user reflected in the recommendation data is any of the inputs that have been made so far by the other user, for example. For example, an input that another user has made in relation to the middle-tier element associated with the lower-tier element of the proposal is the input made by another user reflected in the recommendation data. For example, an input that the certain user has made in relation to the upper-tier element associated with the middle-tier element of such an input made by the other user is an input made by the certain user reflected in the recommendation data.

The expression “the input of the user ID data, the middle-tier data, and the upper-tier data” encompasses a situation where the user ID data, the middle-tier data, and the upper-tier data are inputted while being associated with each other, as exemplified by a situation where the middle-tier data and the upper-tier data are inputted while being associated with the user ID data. It is just required that the user ID data, the middle-tier data, and the upper-tier data be associated, and a timing when these pieces of data are inputted is not particularly limited.

The expression “obtained through the model (for example, the proposal output generation model)” encompasses a case of acquiring it from a database, and a case of using an output from a learned model, for example. The case of acquiring it from a database encompasses a case of using middle-tier data on another user accumulated in a database, for example. The case of using an output from a learned model encompasses a case of using an output from a learned model configured to make an output that reflects middle-tier data on another user, for example. The learned model performs learning in accordance with an input made by a user.

The model (for example, the proposal output generation model) is, for example, configured to output recommendation data when user ID data on a certain user, and middle and upper-tier data in relation to a certain lower-tier element are inputted, such that middle-tier data on another user, who is different from the certain user, is reflected in the recommendation data.

The model (for example, the proposal output generation model) may be, for example, configured to output recommendation data when user ID data on a certain user, and middle and upper-tier data in relation to a certain lower-tier element are inputted, such that not only middle-tier data on another user but also upper-tier data on the other user is reflected in the recommendation data. The expression “upper-tier data on the other user is reflected in the recommendation data” encompasses selecting a user as the other user, the user corresponding to upper-tier data having a relationship with the upper-tier data on the certain user, the relationship satisfying a predetermined condition, for example. The predetermined condition is, for example, that the upper-tier data on the certain user and the upper-tier data on the other user be the same as or similar to each other. If the relationship between the upper-tier data on the certain user and the upper-tier data on the other user satisfies the predetermined condition, the proposal can be given with a further improved accuracy.

For example, reflecting the middle-tier data on the other user in the recommendation data means involvement of the other user in selection of the lower-tier element. The certain user is informed of such involvement of the other user by the involvement data. The involvement data is data for informing the certain user that the other user is involved in selection of the lower-tier element. The involvement data is generated together with the recommendation data, for example. The involvement data is generated by the proposal output generation model, for example.

The involvement data includes middle-tier data on another user who is involved in selection of the lower-tier element, or includes data relating to a lower-tier element associated with a middle-tier element corresponding to the middle-tier data on the other user, for example. The middle-tier data on the other user is data relating to a middle-tier element associated with a lower-tier element related to the recommendation data, that is, a lower-tier element that is different from the certain lower-tier element in relation to which the input has been made by the certain user. The lower-tier element associated with the middle-tier element corresponding to the middle-tier data is the lower-tier element related to the recommendation data.

The involvement of another user means that middle-tier data on another user is reflected in recommendation data when the recommendation data is generated, for example. The certain user is informed of the involvement of another user together with the relevance of the upper-tier element and the middle-tier element in relation to which the input has been made by the certain user, for example. The expression “the upper-tier element and the middle-tier element in relation to which the input has been made by the certain user” is just required to express the upper-tier element corresponding to the upper-tier data and the middle-tier element corresponding to the middle-tier data inputted by the certain user, and a timing when the input is made by the certain user is not particularly limited.

The expression “middle-tier data on another user is reflected in the recommendation data” encompasses a configuration in which middle-tier data on another user is present, and a lower-tier element associated with a middle-tier element corresponding to the middle-tier data is the lower-tier element related to the recommendation data, for example. The expression “middle-tier data on another user is reflected in the recommendation data” encompasses a configuration in which middle-tier data on another user is used for generation of the recommendation data, for example. The expression “middle-tier data on another user is used for generation of the recommendation data” encompasses not only a configuration in which middle-tier data on another user itself is used for generation of the recommendation data but also a configuration in which a learned model is used for generation of the recommendation data, the learned model being configured to make an output that reflects middle-tier data on another user, for example. The learned model performs learning in accordance with an input made by a user.

Another user includes a virtual user as well as a real user, for example. The virtual user includes a virtual entity and a virtual agent, for example. The virtual entity is not a real user. A model of the virtual entity is not updated. A model of the virtual entity may be updated by updating, for example. More specifically, a model of the virtual entity is not updated when the system (e.g., the interactive proposal output system) is used, but may be updated when the system is updated, for example. The virtual agent is not a real user. A model of the virtual agent is capable of updating. A timing when a model of the virtual agent is updated is not particularly limited. A model of the virtual agent is updated as appropriate depending on the situation, for example.

The input section (e.g., the input data receiving section) and the output section are disposed in the same terminal, for example. The terminal can be carried by a user, for example. The terminal is a portable terminal owned by a user, for example. The portable terminal is a smartphone, for example. The input section (e.g., the input data receiving section) includes a touch panel display disposed in the terminal, for example. The output section is a display screen disposed in the terminal, for example. How to output output data is not particularly limited. For example, it is outputted via displaying or sounding. For example, when output data is outputted, the output data is appropriately changed into a form suitable for being outputted. The output data is outputted after input data is received. A timing when the output data is outputted is not particularly limited except that the timing has to be after reception of input data. The output data is outputted in response to input data, for example. The output data is outputted in association with input data, for example.

The system (e.g., the interactive proposal output system) is a recommendation system that gives a proposal in response to a user's input. The system (e.g., the interactive proposal output system) is applied to a use that allows the user to immediately try what is proposed by the system, for example. The system (e.g., the interactive proposal output system) is used to change output characteristics of a power source in a vehicle, for example. The vehicle may be a car, a ship, or a drone, for example. The power source is just required to include an engine or an electric motor, for example.
(5) In the system according to (4),
the involvement data includes the middle-tier data on the other user involved in selection of the lower-tier element, or includes data relating to the lower-tier element associated with the middle-tier element corresponding to this middle-tier data.

In the system of (5), the middle-tier data on the other user reflected in the recommendation data, or data relating to the lower-tier element associated with the middle-tier element corresponding to this middle-tier data is outputted as the involvement data, and thus the certain user can be informed of the reason of the proposal. The reliability of the proposal can be improved.

The involvement data is just required to include a middle-tier element corresponding to middle-tier data on another user involved in selection of the lower-tier element. The involvement data may include a middle-tier element corresponding to middle-tier data on another user involved in selection of the lower-tier element and an upper-tier element corresponding to upper-tier data on the other user, or may include a middle-tier element corresponding to middle-tier data on another user involved in selection of the lower-tier element and a lower-tier element corresponding to lower-tier data on the other user, for example.

In a case of the involvement data including a middle-tier element corresponding to middle-tier data on another user involved in selection of the lower-tier element, the recommendation data may be data relating to a lower-tier element in which the input made by the certain user and an input made by the other user are reflected, for example.
(6) In the system according to (4),
the model includes a middle-tier model part and an upper-tier model part, the middle-tier model part being generated for each of the plurality of users, the middle-tier model part being configured to make an output in response to an input such that the middle-tier data on the user is reflected in said output, the upper-tier model part being generated for each of the plurality of users, the upper-tier model part being configured to make an output in response to an input such that the upper-tier data on the user is reflected in said output, and
the involvement data includes data relating to the upper-tier model part for the other user, or data relating to the middle-tier model part for the other user.

In the system of (6), the model includes the middle-tier model part and the upper-tier model part, which are generated for each of a plurality of users. The middle-tier model part and the upper-tier model part can be used in an appropriate combination. For example, combined use of the upper-tier model part for the certain user and the middle-tier model part for the other user makes it possible that a proposal according to the relevance of the middle-tier element and the lower-tier element of the other user is given in a manner according to the relevance of the upper-tier element and the middle-tier element in relation to which the input has been made by the certain user. The proposal to the certain user can be made with both the accuracy and diversity.

Here, in the system of (6), data relating to the upper-tier model part for another user, or data relating to the middle-tier model part for another user is outputted as the involvement data, and thus the certain user can be informed of the reason of the proposal. The reliability of the proposal can be improved.

The middle-tier model part is generated for each of a plurality of users. The middle-tier model part is configured to make an output in response to an input such that the middle-tier data on the user is reflected in the output. The middle-tier model part performs learning in accordance with an input of data, for example. The data relating to the middle-tier model part for another user refers to, for example, data indicating the relevance between an input to and an output from the middle-tier model part for the other user.

The upper-tier model part is generated for each of a plurality of users. The upper-tier model part is configured to make an output in response to an input such that the upper-tier data on the user is reflected in the output. The upper-tier model part performs learning in accordance with an input of data, for example. The data relating to the upper-tier model part for the certain user refers to, for example, data indicating the relevance between an input to and an output from the upper-tier model part for the certain user.
(7) In the system according to any of (1) to (6),
the lower-tier element, the middle-tier element, and the upper-tier element constitute an evaluation structure for a user's evaluation on an object,
the upper-tier element is a top-level element of the evaluation structure,
the middle-tier element is an element that is a cause of the upper-tier element, and
the lower-tier element is an element that is a cause of the middle-tier element.

In the system of (7), a relationship is built in which a lower-tier element causes a middle-tier element, and the middle-tier element causes an upper-tier element. In the evaluation structure having the upper-tier element as the top-level element, the upper-tier element and the lower-tier element are tied via the middle-tier element. For example, even if the middle-tier element corresponding to the middle-tier data on the certain user is the same as a middle-tier element corresponding to middle-tier data on another user, the lower-tier element that causes the middle-tier element of the certain user may be different from a lower-tier element that causes the middle-tier element of the other user. If such middle-tier data relating to the middle-tier element of the other user is reflected in recommendation data, a lower-tier element that the certain user has never evaluated so far is able to be outputted as the recommendation data. The diversity of a proposal can be improved without the need to collect a wide variety of data. The diversity of a proposal can be improved with a small amount of data.

The expression “the middle-tier element is a cause of the upper-tier element” encompasses a case where the middle-tier element causes the upper-tier element to occur, for example. The expression “the lower-tier element is a cause of the middle-tier element” encompasses a case where the lower-tier element causes the middle-tier element to occur, for example. The lower-tier element, the middle-tier element, and the upper-tier element build such a relationship that the lower-tier element causes the middle-tier element to occur, and this middle-tier element causes the upper-tier element to occur. In the evaluation structure having the upper-tier element as the top-level element, the upper-tier element and the lower-tier element are tied via the middle-tier element.
(8) In the system according to any of (2) to (7),
the model is configured such that, in a case where the middle-tier data and the upper-tier data for a certain lower-tier element are inputted by a certain user,
   another user, who is different from the certain user, is selected through comparison between the middle-tier data on the certain user and the middle-tier data on a user other than the certain user, and
   the middle-tier data on the selected other user is reflected in the recommendation data.

In the system of (8), input data are compared, to select another user. A processing load in selection of another user can be reduced as compared to when the amount of input data is smaller than the amount of data of the models itself, each of which is formed for each of a plurality of users, or when outputs of the models are compared, for example. For example, in a case where a complicated model is used and priority is placed on the responsiveness, comparing input data to select another user can reduce a processing load, and thus can prioritize the responsiveness.

For example, in a case where the middle-tier data on a user other than the certain user is neither identical nor similar to the middle-tier data on the certain user, this user related to the middle-tier data, who is other than the certain user, may be selected as another user. For example, the upper-tier data as well as the middle-tier data may be compared. Comparison of the upper-tier data can further improve the accuracy of a proposal. For example, in a case where the upper-tier data on a user other than the certain user is identical or similar to the upper-tier data on the certain user, this user related to the upper-tier data, who is other than the certain user, may be selected as another user. Since an output from the upper-tier model part for the selected other user is identical or similar to an output from the upper-tier model part for the certain user, the accuracy of a proposal can be improved. Comparison between the middle-tier data on the certain user and the middle-tier data on a user other than the certain user includes classification into a plurality of groups based on the middle-tier data on the certain user and the middle-tier data on a user other than the certain user, for example.
(9) In the system according to any of (2) to (7),
the model includes a middle-tier model part and an upper-tier model part, the middle-tier model part being generated for each of the plurality of users, the middle-tier model part being configured to make an output in response to an input such that the middle-tier data on the user is reflected in said output, the upper-tier model part being generated for each of the plurality of users, the upper-tier model part being configured to make an output in response to an input such that the upper-tier data on the user is reflected in said output,
in a case where the middle-tier data and the upper-tier data for a certain lower-tier element are inputted by a certain user, the model selects another user, who is different from the certain user, by any of (A) to (D) below:
   (A) selecting the other user through comparison between a first model part out of the middle-tier model part and the upper-tier model part for the certain user and the first model part out of the middle-tier model part and the upper-tier model part for a user other than the certain user,
   (B) selecting the other user through comparison between an output from the middle-tier model part for the certain user and an output from the middle-tier model part for a user other than the certain user,
   (C) classifying the plurality of users into a plurality of middle-tier groups by using an output from the middle-tier model part for each of the plurality of users, and selecting the other user from a middle-tier group different from the one to which the certain user belongs out of the plurality of middle-tier groups, or
   (D) presenting to the certain user the middle-tier model parts or the upper-tier model parts for users other than the certain user so that the certain user selects the middle-tier model part or the upper-tier model part from among the presented middle-tier model parts or upper-tier model parts, and selecting, as the other user, a user corresponding to the middle-tier model part or upper-tier model part selected by the certain user, and
the model generates the recommendation data to be outputted, by using a first model part out of the middle-tier model part or the upper-tier model part for the certain user and a second model part out of the middle-tier model part and the upper-tier model part for the selected other user.

In the system of (9), the model includes the middle-tier model part and the upper-tier model part, which are generated for each of a plurality of users. In generating the recommendation data, the second model part corresponding to the selected other user is used. The middle-tier model part and the upper-tier model part can be used in an appropriate combination. For example, combined use of the upper-tier model part for the certain user and the middle-tier model part for the other user makes it possible that a proposal according to the relevance of the middle-tier element and the lower-tier element of the other user is given in a manner according to the relevance of the upper-tier element and the middle-tier element in relation to which the input has been made by the certain user. The proposal to the certain user can be made with both the accuracy and diversity.

An output from the middle-tier model part is obtained by inputting lower-tier data relating to a lower-tier element, for example. An output from the upper-tier model part is obtained by inputting an output from the middle-tier model part, for example.

The method of (A) can be carried out by comparing data relating to the first model part (such as a parameter in this model part), for example. In the method of (A), for example, a user corresponding to a middle-tier model part having a relationship that satisfies a predetermined condition with the middle-tier model part for the certain user may be selected as the other user. In such a case, the predetermined condition is, for example, that the relationship be being neither identical nor similar to the middle-tier model part for the certain user. In the method of (A), for example, a user corresponding to an upper-tier model part having a relationship that satisfies a predetermined condition with the upper-tier model part for the certain user may be selected as the other user. In such a case, the predetermined condition is, for example, that the relationship be being identical or similar to the upper-tier model part for the certain user.

In the method of (B), outputs from the middle-tier model parts are compared. This can reduce a processing load in selecting the other user as compared to comparison between data relating to the middle-tier model parts, if the amount of data relating to the outputs from the middle-tier model part is smaller than the amount of data relating to the middle-tier model parts (for example, parameters in the model parts). For example, in a case where a complicated model is used and priority is placed on the responsiveness, comparing outputs from the middle-tier model parts to select another user can reduce a processing load, and thus can prioritize the responsiveness. The method of (B) can be carried out by comparing outputs that are obtained by inputting lower-tier data relating to lower-tier elements to the middle-tier model parts, for example. For example, in a case where the output from the middle-tier model part for a user other than the certain user is neither identical nor similar to the output from the middle-tier model part for the certain user, this user related to the middle-tier model part, who is other than the certain user, may be selected as another user. In the method of (B), for example, not only the outputs from the middle-tier model parts but also outputs from the upper-tier model parts may be compared. Comparison of the outputs from the upper-tier model parts can further improve the accuracy of a proposal. For example, in a case where the output from the upper-tier model part for a user other than the certain user is identical or similar to the output from the upper-tier model part for the certain user, this user related to the upper-tier model part, who is other than the certain user, may be selected as another user. Since the output from the upper-tier model part for the selected other user is identical or similar to the output from the upper-tier model part for the certain user, the accuracy of a proposal can further be improved.

The method of (C) can reduce a processing load in selecting another user, because another user has only to be selected from the group. Examples of a method for selecting another user from the group include: a method in which identity/similarity of users in the group is determined, and a result of the determination is used; and a method in which a professional user, a famous user, a highly skilled user, or the like, in the group is preferentially selected. The professional user, the famous user, the highly skilled user, or the like, are set in advance, for example. In the method of (C), the output from the middle-tier model part used to classify the plurality of users into the plurality of middle-tier groups is, for example, an output obtained by inputting lower-tier data relating to a lower-tier element to the middle-tier model part. For example, it may be conceivable that ones having the same or similar outputs belong to the same group. The method of (C) may include, for example, not only classifying the plurality of users into a plurality of middle-tier groups by using an output from the middle-tier model part for each of the plurality of users but also classifying the plurality of users into a plurality of upper-tier groups by using an output from the upper-tier model part for each of the plurality of users. In this case, for example, another user is selected from among users who belong to the upper-tier group to which the certain user belongs out of the plurality of upper-tier groups and who also belong to the middle-tier group to which the certain user does not belong out of the plurality of middle-tier groups. Since the selected other user belongs to the same upper-tier group as the certain user does, the accuracy of a proposal can further be improved.

In the method of (D), another user is able to be selected based on an intention of the certain user. The certain user is more likely to be motivated to try a proposal. The users (users other than the certain user) corresponding to the presented middle-tier model parts or upper-tier model parts are famous users, professional users, or highly skilled users, for example. These users are set in advance, for example. The users (users other than the certain user) corresponding to the presented middle-tier model parts or upper-tier model parts may be selected by using a result of a questionnaire to the certain user, for example.
(10) In the system according to (6) or (9),
in a case where the middle-tier data and the upper-tier data for a certain lower-tier element are inputted by a certain user, the model performs learning such that
   the middle-tier data on the certain user is reflected in the middle-tier model part for the certain user, and
   the upper-tier data on the certain user is reflected in the upper-tier model part for the certain user.

In the system of (10), each time data is inputted, the middle-tier model part and the upper-tier model part are updated. The output from each of the middle-tier model part and the upper-tier model part is able to reflect the latest input data. The accuracy and diversity of a proposal can further be improved.

The expression “the middle-tier data on the certain user is reflected in the middle-tier model part for the certain user” encompasses such a phenomenon that, if lower-tier data relating to a lower-tier element associated with a middle-tier element corresponding to the middle-tier data on the certain user is inputted to the middle-tier model part, the middle-tier element corresponding to the middle-tier data on the certain user is outputted from the middle-tier model part, for example.

The expression “the upper-tier data on the certain user is reflected in the upper-tier model part for the certain user” encompasses such a phenomenon that, if middle-tier data relating to a middle-tier element associated with an upper-tier element corresponding to the upper-tier data on the certain user is inputted to the upper-tier model part, the upper-tier element corresponding to the upper-tier data on the certain user is outputted from the upper-tier model part, for example.

The expression “performs learning” encompasses updating a model part such that input data is reflected in the relevance of an input and an output of the model part, for example. Updating a model part encompasses changing a parameter, or the like, in the model part, for example.
(11) In the system according to any of (6), (9), and (10),
the middle-tier model part is generated for each of the plurality of users, and is configured to make an output in response to an input of lower-tier data relating to the lower-tier element such that the output reflects the middle-tier data on the user, and
the upper-tier model part is generated for each of the plurality of users, and is configured to receive an input that is an output from the middle-tier model part, and to make an output in response to the input such that the output reflects upper-tier data on the user.

In the system of (11), the output from the upper-tier model part is caused by the output from the middle-tier model part. The output from the middle-tier model part and the output from the upper-tier model part can be associated.

For example, suppose a case where a middle-tier model part for another user and an upper-tier model part for the certain user are used in combination. In this case, a proposal according to the relevance of a middle-tier element and a lower-tier element of the other user can be given in a manner according to the relevance of an upper-tier element and a middle-tier element in relation to which the input has been made by the certain user. A lower-tier element that is associated with the middle-tier element of the other user and that is different from the certain lower-tier element in relation to which the input has been made by the certain user is able to be proposed to the certain user in a manner according to the relevance of the upper-tier element and the middle-tier element in relation to which the input has been made by the certain user.

For example, suppose a case where a middle-tier model part for another user and an upper-tier model part for the certain user are used in combination. In this case, a plurality of pieces of lower-tier data are inputted to the middle-tier model part for the other user, and a plurality of outputs obtained from the middle-tier model part for the other user are inputted to the upper-tier model part for the certain user, to obtain a plurality of outputs, which are a plurality of outputs obtained from the upper-tier model part for the certain user. By using these plurality of outputs, a reaction of the certain user to a proposal to the certain user can be predicted. Even a lower-tier element that has never been inputted by users or a lower-tier element that has been inputted by not many users is able to be proposed. Since a reaction of the certain user to a proposal to the certain user can be predicted, a reduced amount of data is required to give a proposal with a high accuracy.

For the configuration “the upper-tier model part receives an input that is an output from the middle-tier model part,” it is just required that an output from the middle-tier model part be used as an input to the upper-tier model part. For example, an output from the middle-tier model part may not always have to be directly inputted to the upper-tier model part. For example, it may be acceptable that an output from the middle-tier model part is stored in a memory, and the output from the middle-tier model part read out from the memory is inputted to the upper-tier model part.
(12) In the system according to (11),
the model is configured such that, in a case where the middle-tier data and the upper-tier data for a certain lower-tier element are inputted by a certain user,
   a plurality of pieces of the lower-tier data are inputted to the middle-tier model part for another user, who is different from the certain user,
   a plurality of outputs obtained from the middle-tier model part for the other user are inputted to the upper-tier model part for the certain user,
   a plurality of outputs obtained from the upper-tier model part for the certain user are compared, and
   by using a result of the comparison, the recommendation data to be outputted is generated.

In the system of (12), a plurality of outputs obtained from the middle-tier model part for the selected other user are inputted to the upper-tier model part for the certain user so that a plurality of outputs are obtained from the upper-tier model part for the certain user, and these plurality of outputs are compared, a result of which is used in generation of the recommendation data. A lower-tier element according to the relevance of the middle-tier element and the lower-tier element of the other user can be found in accordance with the relevance of the upper-tier element and the middle-tier element of the certain user. Even with a lower-tier element that has never been inputted by users or a lower-tier element that has been inputted by not many users, a proposal is able to be proposed in a manner according to the relevance of the upper-tier element and the middle-tier element of the certain user. A reaction of the certain user to a proposal to the certain user can be predicted. Since a reaction of the certain user to a proposal to the certain user can be predicted, a reduced amount of data is required to give a proposal with a high accuracy.

The expression “a plurality of outputs obtained from the upper-tier model part for the certain user are compared, and by using a result of the comparison, the recommendation data to be outputted is generated” encompasses a configuration in which, for example, an output that is most according to the relevance of the upper-tier element and the middle-tier element of the certain user is selected from among a plurality of outputs, and a lower-tier element according to lower-tier data corresponding to this selected output is selected as the recommendation data.
(1) A terminal according to an embodiment of the present teaching includes:
an input section; and
an output section,
the input section being configured to receive at least intermediate-tier data inputted by each of a plurality of users, the intermediate-tier data relating to a middle-tier element, which is inputted in association with each of a lower-tier element and an upper-tier element,
the output section being configured to, in a case where the intermediate-tier data is inputted by a certain user, output output data in accordance with the input of the intermediate-tier data, the output data including recommendation data obtained through a model external to the terminal,
the model being configured to acquire the intermediate-tier data on each of the plurality of users, and configured in a way where the intermediate-tier data on each of the plurality of users and recommendation data are associated based on the acquired intermediate-tier data on each of the plurality of users such that:
   as the acquired intermediate-tier data on a certain user changes, the recommendation data for giving a recommendation to the certain user changes, or
   even if the acquired intermediate-tier data on a certain user is unchanged, the recommendation data for giving a recommendation to the certain user changes.

The terminal of (1), like the system according to the embodiment of the present teaching, makes it possible to reduce a processing load while achieving both the accuracy and diversity of a proposal. To put it another way, given that the processing load is equal to or similar to a conventional one, both the accuracy and diversity of a proposal can be achieved at a higher level.
(2) The terminal according to (1) includes, for example, the following configuration.

The intermediate-tier data includes middle-tier data and upper-tier data, the middle-tier data relating to the middle-tier element, which is inputted in association with the lower-tier element, the upper-tier data relating to the upper-tier element, which is inputted in association with the middle-tier element,
the output section is configured to, in a case where the middle-tier data and the upper-tier data for a certain lower-tier element are inputted by a certain user, output the output data in accordance with the input of the middle-tier data and the upper-tier data, the output data including the recommendation data obtained through the model external to the terminal,
the model is a proposal output generation model configured to, in a case where the middle-tier data and the upper-tier data for a certain lower-tier element are inputted by a certain user, output the recommendation data in accordance with the input of the middle-tier data and the upper-tier data, and
the recommendation data is data relating to a lower-tier element that is different from the certain lower-tier element in relation to which the input has been made by the certain user.
(3) The terminal according to (2) includes, for example, the following configuration.

The model is configured to, in a case where the middle-tier data and the upper-tier data for a certain lower-tier element are inputted by a certain user, output the recommendation data in accordance with the input of the middle-tier data and the upper-tier data, such that the middle-tier data on another user, who is different from the certain user, is reflected in the recommendation data.
(4) The terminal according to (2) or (3) includes, for example, the following configuration.

The output data further includes involvement data, and
the involvement data is data for informing the certain user that another user, who is different from the certain user, is involved in selection of the lower-tier element related to the recommendation data.

The terminal of (2) may further include a transmitting section for, in a case where the middle-tier data and the upper-tier data for a certain lower-tier element are inputted by a certain user, transmitting the middle-tier data and the upper-tier data to the outside of the terminal, for example.

The terminal of (2) may further include a receiving section for receiving recommendation data obtained through a model external to the terminal in accordance with the input of the middle-tier data and the upper-tier data, for example. In this case, the output section outputs the output data received, that is, the recommendation data received. The receiving section may further receive involvement data. In this case, the output section outputs the recommendation data and involvement data received.

The terminal of (1) is produced by, for example, the terminal being installed with the following application program. The terminal of (1) produced in this manner is used through operations of the installed application program, for example. The installation of the application program used may be implemented automatically after the application program is downloaded, or may be implemented by following an instruction given through a dialog box that prompts for installation, the dialog box being displayed after the application program is downloaded, for example. The installation of the application program is triggered by a user's action, for example. The user's action is to download the application program, or to follow an instruction given through a dialog box that is displayed after the application program is downloaded, for example. The user's action can be interpreted as: an action in which the user requests a distributor or provider of the application program to install the application program; an action in which the user requests the distributor or provider of the application program to install the application program in a terminal, and to make the terminal available for use as the terminal of (1); or an action in which the user requests the distributor or provider of the application program to produce the terminal of (1), for example. Starting an installer for the application program and installing the application program, or installing the application program in a terminal and making the terminal available for use as the terminal of (1) can be interpreted as an action that the distributor or provider of the application program performs in accordance with a request from the user, for example. That is, the terminal of (1) is produced in response to a request from the user, for example. An operation that is automatically carried out in the course of installation of the application program is included in an action that the distributor or provider of the application program performs in order to automatically respond to a request from the user, for example.
(1) An application program according to an embodiment of the present teaching is an application program configured to cause a terminal to execute a process of:
receiving input data; and
outputting of output data in accordance with reception of the input data, in which
the receiving of the input data is reception of the input data including intermediate-tier data, which is data relating to a middle-tier element inputted in association with each of a lower-tier element and an upper-tier element,
the outputting the output data in accordance with reception of the input data is, in a case where the intermediate-tier data is inputted by a certain user, outputting the output data in accordance with the input of the intermediate-tier data, the output data including recommendation data obtained through a model external to the terminal, and
the model is configured to acquire the intermediate-tier data on each of the plurality of users, and configured in a way where the intermediate-tier data on each of the plurality of users and recommendation data are associated based on the acquired intermediate-tier data on each of the plurality of users such that:
   as the acquired intermediate-tier data on a certain user changes, the recommendation data for giving a recommendation to the certain user changes, or
   even if the acquired intermediate-tier data on a certain user is unchanged, the recommendation data for giving a recommendation to the certain user changes.

The application program of (1), like the system according to the embodiment of the present teaching, makes it possible to reduce a processing load while achieving both the accuracy and diversity of a proposal. To put it another way, given that the processing load is equal to or similar to a conventional one, both the accuracy and diversity of a proposal can be achieved at a higher level.
(2) The application program according to (1) includes, for example, the following configuration.

The intermediate-tier data includes middle-tier data and upper-tier data, the middle-tier data relating to the middle-tier element, which is inputted in association with the lower-tier element, the upper-tier data relating to the upper-tier element, which is inputted in association with the middle-tier element,
the outputting the output data in accordance with reception of the input data is, in a case where the middle-tier data and the upper-tier data for a certain lower-tier element are inputted by a certain user, outputting the output data in accordance with the input of the middle-tier data and the upper-tier data, the output data including the recommendation data obtained through the model external to the terminal,
the model is a proposal output generation model configured to, in a case where the middle-tier data and the upper-tier data for a certain lower-tier element are inputted by a certain user, output the recommendation data in accordance with the input of the middle-tier data and the upper-tier data, and
the recommendation data is data relating to a lower-tier element that is different from the certain lower-tier element in relation to which the input has been made by the certain user.
(3) The application program according to (2) includes, for example, the following configuration.

The model is configured to, in a case where the middle-tier data and the upper-tier data for a certain lower-tier element are inputted by a certain user, output the recommendation data in accordance with the input of the middle-tier data and the upper-tier data, such that the middle-tier data on another user, who is different from the certain user, is reflected in the recommendation data.
(4) The application program according to (2) or (3) includes, for example, the following configuration.

The output data further includes involvement data, and
the involvement data is data for informing the certain user that another user, who is different from the certain user, is involved in selection of the lower-tier element related to the recommendation data.

The application program of (2) may be configured to, in a case where the middle-tier data and the upper-tier data for a certain lower-tier element are inputted by a certain user, transmit the middle-tier data and the upper-tier data to the outside of the terminal, for example.

The application program of (2) may be configured to receive output data including recommendation data obtained through a model external to the terminal in accordance with the input of the middle-tier data and the upper-tier data, for example. In this case, the output data received is outputted. The output data may further include involvement data.
(1) A method performed by a terminal according to an embodiment of the present teaching is a method performed by a terminal, the method including:
receiving input data; and
outputting of output data in accordance with reception of the input data, in which
the receiving of the input data is reception of the input data including intermediate-tier data, which is data relating to a middle-tier element inputted in association with each of a lower-tier element and an upper-tier element,
the outputting the output data in accordance with reception of the input data is, in a case where the intermediate-tier data is inputted by a certain user, outputting the output data in accordance with the input of the intermediate-tier data, the output data including recommendation data obtained through a model external to the terminal, and
the model is configured to acquire the intermediate-tier data on each of the plurality of users, and configured in a way where the intermediate-tier data on each of the plurality of users and recommendation data are associated based on the acquired intermediate-tier data on each of the plurality of users such that:
   as the acquired intermediate-tier data on a certain user changes, the recommendation data for giving a recommendation to the certain user changes, or
   even if the acquired intermediate-tier data on a certain user is unchanged, the recommendation data for giving a recommendation to the certain user changes.

The method performed by the terminal of (1), like the system according to the embodiment of the present teaching, makes it possible to reduce a processing load while achieving both the accuracy and diversity of a proposal. To put it another way, given that the processing load is equal to or similar to a conventional one, both the accuracy and diversity of a proposal can be achieved at a higher level.
(2) The method performed by the terminal according to (1) includes, for example, the following configuration.

The intermediate-tier data includes middle-tier data and upper-tier data, the middle-tier data relating to the middle-tier element, which is inputted in association with the lower-tier element, the upper-tier data relating to the upper-tier element, which is inputted in association with the middle-tier element,
the outputting the output data in accordance with reception of the input data is, in a case where the middle-tier data and the upper-tier data for a certain lower-tier element are inputted by a certain user, outputting the output data in accordance with the input of the middle-tier data and the upper-tier data, the output data including the recommendation data obtained through the model external to the terminal,
the model is a proposal output generation model configured to, in a case where the middle-tier data and the upper-tier data for a certain lower-tier element are inputted by a certain user, output the recommendation data in accordance with the input of the middle-tier data and the upper-tier data, and
the recommendation data is data relating to a lower-tier element that is different from the certain lower-tier element in relation to which the input has been made by the certain user.
(3) The method performed by the terminal according to (2) includes, for example, the following configuration.

The model is configured to, in a case where the middle-tier data and the upper-tier data for a certain lower-tier element are inputted by a certain user, output the recommendation data in accordance with the input of the middle-tier data and the upper-tier data, such that the middle-tier data on another user, who is different from the certain user, is reflected in the recommendation data.
(4) The method performed by the terminal according to (2) or (3) includes, for example, the following configuration.

The output data further includes involvement data, and
the involvement data is data for informing the certain user that another user, who is different from the certain user, is involved in selection of the lower-tier element related to the recommendation data.

The method performed by the terminal of (2) may be configured to, in a case where the middle-tier data and the upper-tier data for a certain lower-tier element are inputted by a certain user, transmit the middle-tier data and the upper-tier data to the outside of the terminal, for example.

The method performed by the terminal of (2) may be configured to receive output data including recommendation data obtained through a model external to the terminal in accordance with the input of the middle-tier data and the upper-tier data, for example. In this case, the output data received is outputted. The output data may further include involvement data.

Terms, and the like, as used in relation to the terminals of (1) to (4), the application programs of (1) to (4), and the methods performed by the terminals of (1) to (4) can be explained by applying the explanations of terms, and the like, as used in relation to the systems of (1) to (4), for example.

The terminals of (1) to (4), the application programs of (1) to (4), and the methods performed by the terminals of (1) to (4) may include an aspect of any of the systems of (5) to (12), for example. In such a case, terms, and the like, as used in the aspect included in the terminals of (1) to (4), the application programs of (1) to (4), and the methods performed by the terminals of (1) to (4), that is, the aspect of any of the systems of (5) to (12), can be explained by applying the explanation of terms, and the like, as used in relation to the corresponding aspect, that is, the aspect of any of the system of (5) to (12), for example.

These and other objects, features, aspects, and advantages of the present teaching will become more apparent from the following detailed description of embodiment(s) of the present teaching, with reference to the accompanying drawings. As used herein, the term “and/or” includes any and all combinations of one or more of the associated listed items. As used herein, the terms “including,” “comprising,” or “having,” and variations thereof specify the presence of stated features, steps, operations, elements, components, and/or equivalents thereof, and can include one or more of steps, operations, elements, components, and/or their groups. Unless otherwise defined, all terms (including technical and scientific terms) used herein have the same meaning as commonly understood by one of ordinary skill in the art to which the present teaching belongs. It will be further understood that terms, such as those defined in commonly used dictionaries, should be interpreted as having a meaning that is consistent with their meaning in the context of the present disclosure and relevant art and should not be interpreted in an idealized or overly formal sense unless expressly so defined herein. It will be understood that the description of the present teaching discloses a number of techniques and steps. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, Description and Claims should be read with the understanding that such combinations are entirely within the scope of the present teaching and the claims. In the description given below, for the purposes of explanation, numerous specific details are set forth in order to provide a thorough understanding of the present teaching. It will be apparent, however, that those skilled in the art may practice the present teaching without these specific details. The present disclosure is to be considered as an exemplification of the present teaching, and is not intended to limit the present teaching to the specific embodiments illustrated by the drawings or descriptions provided below.

### Advantageous Effects of Invention

The present teaching provides a system capable of reducing a processing load while achieving both the accuracy and diversity of a proposal, to consequently allow downsizing of hardware resources.

### BRIEF DESCRIPTION OF DRAWINGS

FIG. 1 is a conceptual diagram showing a configuration of an interactive proposal output system according to an embodiment of the present teaching

FIG. 2 is a flow diagram showing an operation of the interactive proposal output system shown in FIG. 1

FIG. 3 is an illustrative diagram for explanation of an exemplary output of involvement data

FIG. 4 is a conceptual diagram showing a configuration of an interactive proposal output system according to a variation of the embodiment of the present teaching

FIG. 5 is a conceptual diagram for explanation of a middle-tier model part and a upper-tier model part in the variation

FIG. 6 is a flow diagram showing an operation of the interactive proposal output system shown in FIG. 4

FIG. 7 is an illustrative diagram for explanation of an example of selecting another user by method (A) in the interactive proposal output system shown in FIG. 4

FIG. 8 is an illustrative diagram for explanation of an example of selecting another user by method (B) in the interactive proposal output system shown in FIG. 4

FIG. 9 is an illustrative diagram for explanation of an example of selecting another user by method (C) in the interactive proposal output system shown in FIG. 4

FIG. 10 is an illustrative diagram for explanation of an example of selecting another user by method (D) in the interactive proposal output system shown in FIG. 4

FIG. 11 is a conceptual diagram for explanation of a model that is used in generation of recommendation data to be outputted in the interactive proposal output system shown in FIG. 4

FIG. 12 is an illustrative diagram for explanation of an exemplary output of involvement data in the interactive proposal output system shown in FIG. 4

### DESCRIPTION OF EMBODIMENTS

In the following, details of a system according to an embodiment of the present teaching will be described with reference to the drawings. Here, it should be noted that the embodiment described below is merely an example. The present teaching should not be construed as being limited in any way by the embodiment described below.

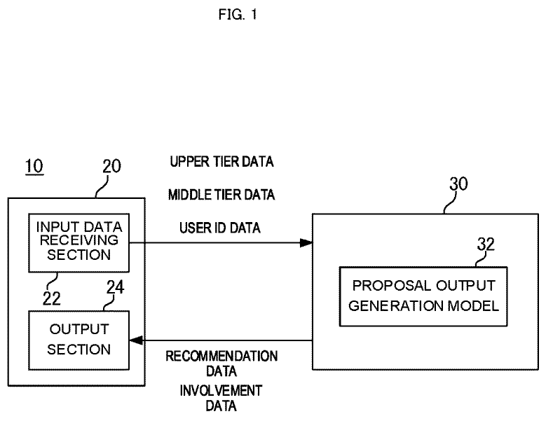

An interactive proposal output system 10 as the system according to the embodiment of the present teaching will be described with reference to FIG. 1. The interactive proposal output system 10 includes an input data receiving section 22, which serves as an input section, and an output section 24.

The input data receiving section 22 receives input data with regard to each of a plurality of users. The input data includes user ID data, middle-tier data, which is intermediate-tier data, and upper-tier data. The middle-tier data is data relating to a middle-tier element, which is inputted in association with a lower-tier element. The upper-tier data is data relating to an upper-tier element, which is inputted in association with the middle-tier element.

The lower-tier element, the middle-tier element, and the upper-tier element are just required to be in such a relationship that the lower-tier element and the middle-tier element are associated with each other while the middle-tier element and the upper-tier element are associated with each other. For example, it may be conceivable that the lower-tier element, the middle-tier element, and the upper-tier element constitute an evaluation structure for a user's evaluation on an object. In such a configuration, the upper-tier element is a top-level element of the evaluation structure. The middle-tier element is an element that is a cause of the upper-tier element. The lower-tier element is an element that is a cause of the middle-tier element.

The output section 24 outputs output data in response to reception of input data. When user ID data on a certain user, and middle and upper-tier data in relation to a certain lower-tier element are inputted, the output section 24 outputs output data including involvement data and recommendation data obtained through a proposal output generation model 32, which serves as a model, in response to the reception of the user ID data and the middle and upper-tier data.

In this embodiment, the input data receiving section 22 and the output section 24 are disposed in a terminal 20. The terminal 20 is owned by each of the plurality of users, for example. The example shown in FIG. 1 illustrates only the terminal 20 owned by a certain user.

The proposal output generation model 32 is configured to output recommendation data in a case where user ID data on a certain user and middle and upper-tier data in relation to a certain lower-tier element are inputted, such that the recommendation data reflects middle-tier data on another user, who is different from the certain user. In this embodiment, the proposal output generation model 32 is provided in a cloud 30.

Here, the recommendation data is data relating to a lower-tier element that is different from a certain lower-tier element related to an input received from the certain user. The involvement data is data for informing the certain user that another user is involved in selection of the lower-tier element.

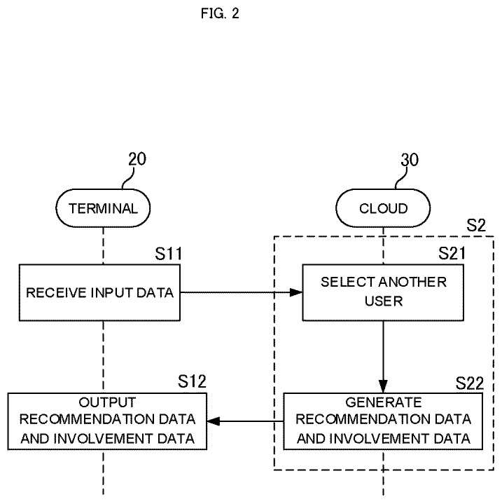

An operation of the interactive proposal output system 10 will be described with reference to FIG. 2. The input data receiving section 22 receives input data in step S11. The input data is transmitted to the cloud 30. The cloud 30 executes a proposal output generation process in step S2. To be specific, the proposal output generation model 32 selects another user in S21. For example, another user is selected based on comparison between middle-tier data on the certain user and middle-tier data on a user other than the certain user. The proposal output generation model 32 generates recommendation data and involvement data in S22. The generated recommendation data and involvement data are transmitted to the terminal 20. The output section 24 outputs the recommendation data and the involvement data in S12.

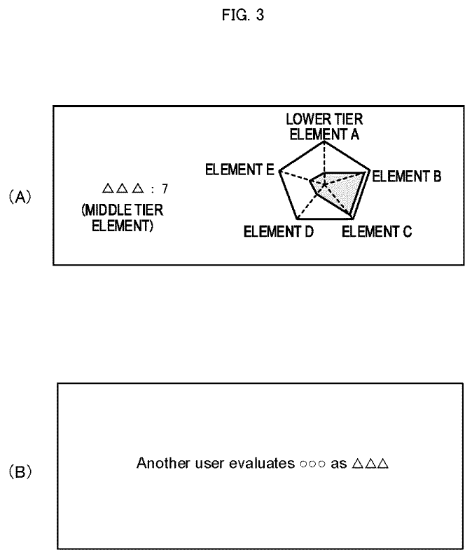

An exemplary output of the involvement data will be described with reference to FIG. 3. In an example shown in FIG. 3, involvement data is displayed on a display screen of the terminal 20. In an example shown in (A) of FIG. 3, the involvement data includes middle-tier data on another user who is involved in selection of a lower-tier element. In the example shown in (A) of FIG. 3, the display is made by using texts and images. Alternatively, for example, only texts may be used for the display, like in an example shown in (B) of FIG. 3. In the example shown in (B) of FIG. 3, “○○○” is a part corresponding to the lower-tier element, and “evaluates as ΔΔΔ” is a part corresponding to a middle-tier element.

The interactive proposal output system 10 is able to reduce a processing load while achieving both the accuracy and diversity of a proposal. To put it another way, given that the processing load is equal to or similar to a conventional one, both the accuracy and diversity of a proposal can be achieved at a higher level.

In the interactive proposal output system 10, the involvement data is not indispensable.

### Variation

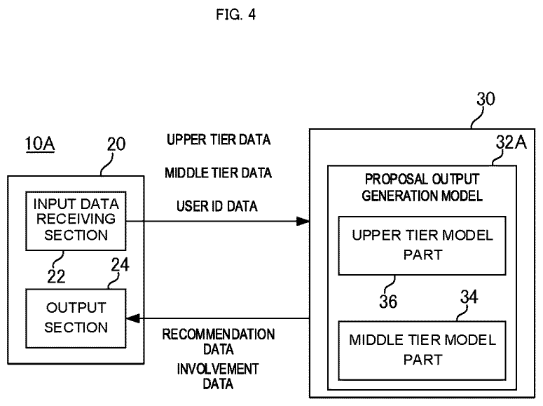

FIG. 4 shows an interactive proposal output system 10A according to a variation. The interactive proposal output system 10A is different from the interactive proposal output system 10 in that a proposal output generation model 32A is employed instead of the proposal output generation model 32. The proposal output generation model 32A includes a middle-tier model part 34 and an upper-tier model part 36. In FIG. 4, only the middle-tier model part 34 and the upper-tier model part 36 for a certain user are shown. Actually, however, the middle-tier model part 34 and the upper-tier model part 36 are generated for each of a plurality of users.

The middle-tier model part 34, which is generated for each of a plurality of users, is configured to make an output in response to an input such that the output reflects middle-tier data on the user. The upper-tier model part 36, which is generated for each of a plurality of users, is configured to make an output in response to an input such that the output reflects upper-tier data on the user.

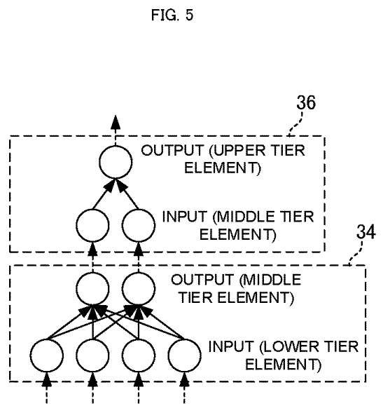

The middle-tier model part 34 and the upper-tier model part 36 in this variation will be described with reference to FIG. 5. In FIG. 5, the middle-tier model part 34 and the upper-tier model part 36 for a certain user are shown. In this variation, the middle-tier model part 34 is generated for each of a plurality of users, and is configured to make an output in response to an input of lower-tier data relating to a lower-tier element such that the output reflects middle-tier data on the user. The upper-tier model part 36 is generated for each of a plurality of users, and is configured to receive an input that is the output from the middle-tier model part 34, and to make an output in response to the input such that the output reflects upper-tier data on the user.

In this variation, if user ID data on a certain user and middle and upper-tier data on a certain lower-tier element are inputted, the proposal output generation model 32A performs learning such that the middle-tier data on the certain user is reflected in the middle-tier model part for this certain user while the upper-tier data on the certain user is reflected in the upper-tier model part for this certain user. Thus, in this variation, each time data is inputted by a user, the middle-tier model part 34 and the upper-tier model part 36 for this user are each updated.

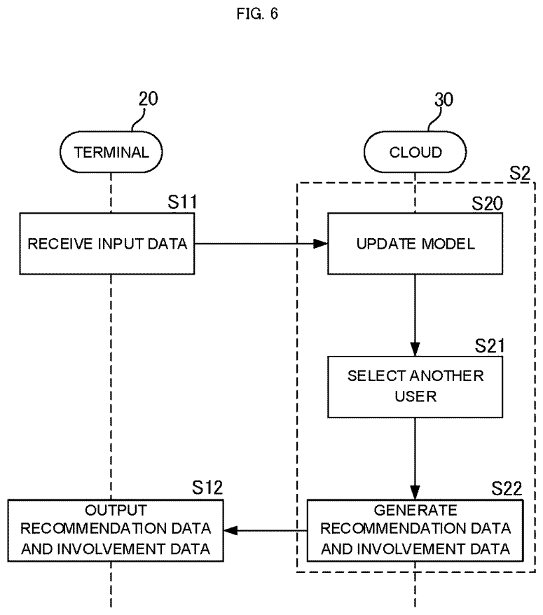

An operation of the interactive proposal output system 10A will be described with reference to FIG. 6. The operation of the interactive proposal output system 10A is different from the operation of the interactive proposal output system 10 in that the model is updated in S20. To be specific, the proposal output generation model 32A uses input data received from the terminal 20, to update the middle-tier model part 34 and the upper-tier model part 36 for a user related to this input data. The user is identified based on user ID data included in the input data. After the model is updated, another user is selected in S21.

How to select another user is not limited to the one adopted in the foregoing embodiment. In this variation, for example, another user may be selected by (A) to (D) below.
(A) Another user is selected through comparison between a first model part out of the middle-tier model part and the upper-tier model part for the certain user and the first model part out of the middle-tier model part and the upper-tier model part for a user other than the certain user.
(B) Another user is selected through comparison between an output from the middle-tier model part for the certain user and an output from the middle-tier model part for a user other than the certain user.
(C) An output from the middle-tier model part for each of a plurality of users is used to classify the plurality of users into a plurality of middle-tier groups, and another user is selected from a middle-tier group to which the certain user does not belong out of the plurality of middle-tier groups.
(D) The middle-tier model parts or the upper-tier model parts for users other than the certain user are presented to the certain user so that the certain user selects a middle-tier model part or an upper-tier model part from among the presented middle-tier model parts or upper-tier model parts, and a user corresponding to the middle-tier model part or upper-tier model part selected by the certain user is selected as another user.

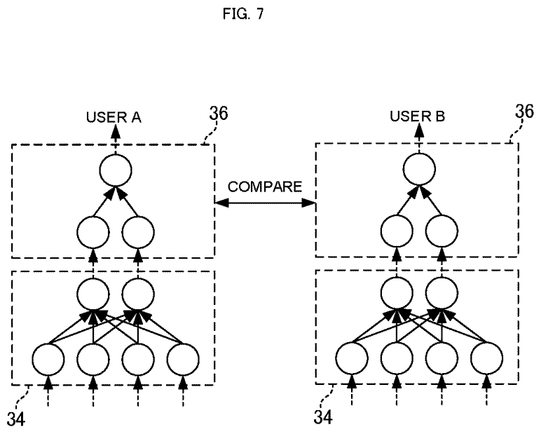

In (A), for example, as shown in FIG. 7, the upper-tier model part 36 for the certain user (user A) and the upper-tier model part 36 for a user (user B) other than the certain user are compared, to select another user.

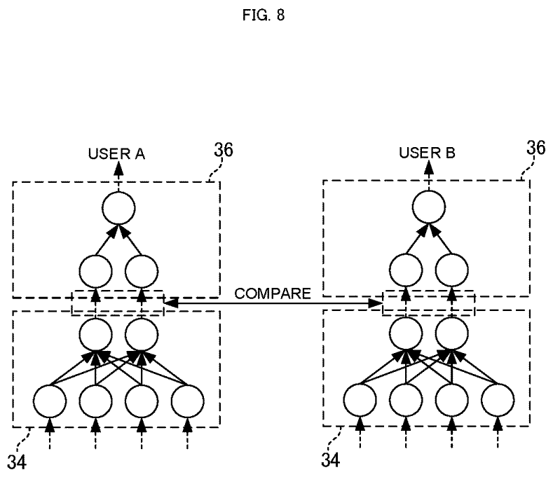

In (B), for example, as shown in FIG. 8, an output from the middle-tier model part 34 for the certain user (user A) and an output from the middle-tier model part 34 for a user (user B) other than the certain user are compared, to select another user.

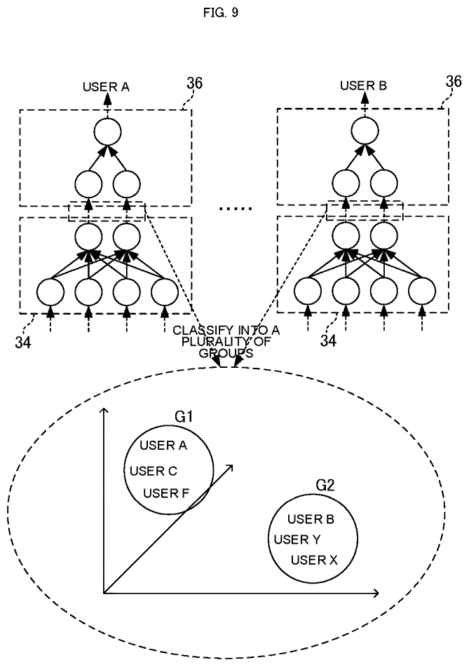

In (C), for example, as shown in FIG. 9, a plurality of users are classified into a plurality of groups G1, G2. Another user is selected from the group G2, which is different from the group G1 to which the user A belongs.

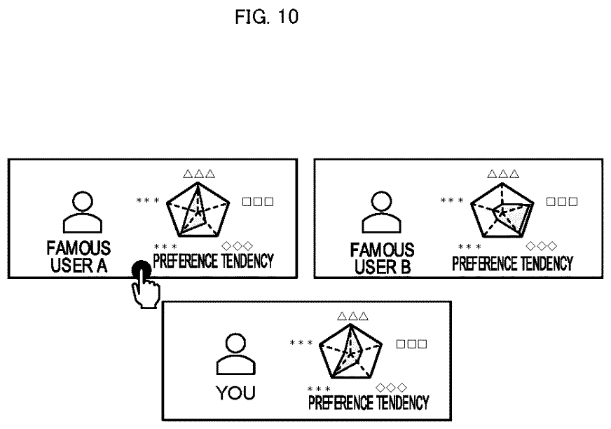

In (D), for example, as shown in FIG. 10, data relating to the upper-tier model part for the certain user and data relating to the upper-tier model part for users other than the certain user are displayed on the screen of the terminal 20, to allow the certain user to select another user.

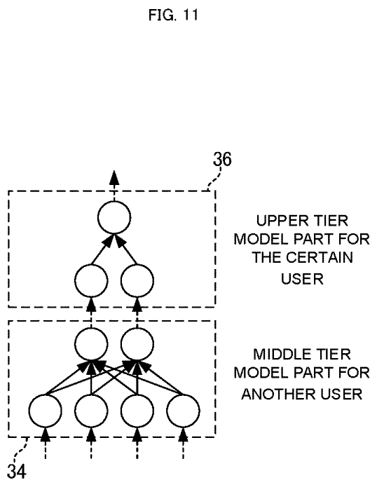

After another user is selected, the proposal output generation model 32A generates recommendation data and involvement data in S22. In this variation, the proposal output generation model 32A generates recommendation data to be outputted, by using a first model part out of the middle-tier model part 34 and the upper-tier model part 36 for the certain user and a second model part out of the middle-tier model part 34 and the upper-tier model part 36 for the selected other user. In this variation, for example, as shown in FIG. 11, a model is generated in which the upper-tier model part 36 for the certain user is combined with the middle-tier model part 34 for the selected other user. By using an output from this model, recommendation data is generated. For example, a plurality of pieces of lower-tier data are inputted to the middle-tier model part 34; a plurality of outputs obtained from the middle-tier model part 34 are inputted to the upper-tier model part 36; a plurality of outputs obtained from the upper-tier model part 36 are compared to each other; and a result of the comparison is used to generate recommendation data. Since the output from the upper-tier model part 36 is referred to, how the certain user will react to the recommendation data to be outputted is predictable. A proposal can be given with a further improved accuracy.

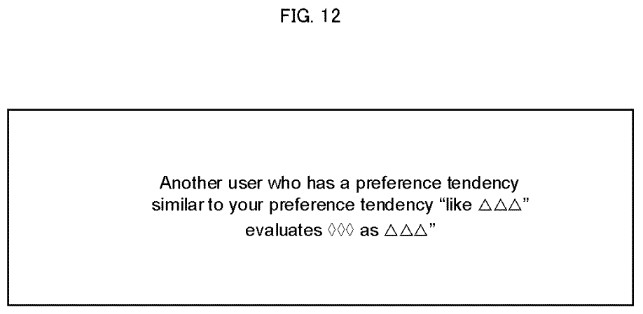

The terminal 20, in step S12, outputs recommendation data and involvement data. An exemplary output of the involvement data will be described with reference to FIG. 12. In an example shown in FIG. 12, involvement data is displayed on the display screen of the terminal 20. In the example shown in FIG. 12, the involvement data includes data relating to an upper-tier model part for another user, or data relating to a middle-tier model part for another user. In the example shown in FIG. 12, “evaluates ⋄⋄⋄ as ΔΔΔ” is a part corresponding to the data relating to the middle-tier model part for another user. On the other hand, “like ΔΔΔ” is a part corresponding to the data relating to the upper-tier model part for the certain user.

The interactive proposal output system 10A described above is also able to reduce a processing load while achieving both the accuracy and diversity of a proposal. To put it another way, given that the processing load is equal to or similar to a conventional one, both the accuracy and diversity of a proposal can be achieved at a higher level.

In the interactive proposal output system 10A, too, the involvement data is not indispensable.

### Other Embodiments

The embodiments and variations, of which at least either one of description or illustration has been given herein, are for ease of understanding the present disclosure, and not for limiting the concept of the present disclosure. The foregoing embodiments and variations may be altered and/or adapted without departing from the spirit of the present disclosure. The spirit encompasses equivalent elements, modifications, omissions, combinations (for example, a combination of features of any embodiment and any variation), adaptations and/or alterations as would be appreciated by those skilled in the art based on the embodiments disclosed herein. The limitations in Claims are to be broadly interpreted based on the language employed in Claims and not limited to embodiments and variations described herein or during the prosecution of the present application. The embodiments and variations are to be construed as non-exclusive. For example, in this Description, the terms “preferably,” “may,” and “possible,” are non-exclusive and mean “preferably, but not limited to,” “may, but not limited to,” and “possibly, but not limited to,” respectively.

### REFERENCE SIGNS LIST

10 interactive proposal output system
22 input data receiving section
24 output section
32 proposal output generation model

1. A system for generating a recommendation to a first user based on an evaluation structure for a plurality of users, the evaluation structure being hierarchical and including a lower-tier element, a middle-tier element and an upper-tier element, the plurality of users including the first user and a second user, the system comprising:
an input section;
a model; and
an output section,
the input section being configured to receive at least intermediate-tier data inputted by each of the plurality of users, the intermediate-tier data relating to the middle-tier element, which is in association with either the lower-tier element or the upper-tier element,
the model being configured to acquire the intermediate-tier data on each of the plurality of users, and to generate recommendation data for generating the recommendation to the first user based on the acquired intermediate-tier data, such that:
as the acquired intermediate-tier data of the first user changes, the recommendation data changes, or
even if the acquired intermediate-tier data of the first user is unchanged, the recommendation data changes.

2. The system according to claim 1, wherein
the system is an interactive proposal output system;
the intermediate-tier data includes:
middle-tier data relating to the middle-tier element, which is inputted in association with the lower-tier element, and
upper-tier data relating to the upper-tier element, which is inputted in association with the middle-tier element;
the output section is configured to generate output data in response to the middle-tier data and the upper-tier data in relation to the lower-tier element being inputted by the first user, the output data including the recommendation data obtained through the model in accordance with the middle-tier data and the upper-tier data;
the model is a proposal output generation model configured to, in response to the middle-tier data and the upper-tier data in relation to the lower-tier element being inputted by the first user, output the recommendation data in accordance with the middle-tier data and the upper-tier data;
the lower-tier element is a first lower-tier element, and the evaluation structure further includes a second lower-tier element different from the first lower-tier element; and
the recommendation data relates to the second lower-tier element.

3. The system according to claim 2, wherein
the model is configured to output the recommendation data that reflects the middle-tier data of the second user.

4. The system according to claim 2, wherein
the output data further includes involvement data, and
the involvement data is data for informing the first user that the second user is involved in selection of the second lower-tier element.

5. The system according to claim 4, wherein
the involvement data includes the middle-tier data of the second user, or includes data relating to the second lower-tier element associated with the middle-tier element corresponding to said middle-tier data.

6. The system according to claim 4, wherein
the model includes:
a middle-tier model part generated for each of the plurality of users, the middle-tier model part being configured to generate an output that reflects the middle-tier data of each user, and
an upper-tier model part generated for each of the plurality of users, the upper-tier model part being configured to generate an output that reflects the upper-tier data of each user, and
the involvement data includes data relating to the upper-tier model part for the second user, or includes data relating to the middle-tier model part for the second user.

7. The system according to claim 1, wherein
the upper-tier element is a top-level element of the evaluation structure,
the middle-tier element corresponds to a cause of the upper-tier element, and
the lower-tier element corresponds to a cause of the middle-tier element.

8. The system according to claim 2, wherein
the model is configured such that, in response to the middle-tier data and the upper-tier data in relation to the first lower-tier element being inputted by the first user,
the second user is selected through comparison between the middle-tier data on the first user and the middle-tier data on the second user, and
the middle-tier data on the second user is reflected in the recommendation data.

9. The system according to claim 2, wherein
the model includes:
a middle-tier model part generated for each of the plurality of users, the middle-tier model part being configured to generate an output that reflects the middle-tier data of the first user,
an upper-tier model part generated for each of the plurality of users, the upper-tier model part being configured to generate an output in response to an input that reflects the upper-tier data of the first user,
in response to the middle-tier data and the upper-tier data in relation to the lower-tier element being inputted by the first user, the model selects the second user by any of (A) to (D) below:
(A) selecting the second user through comparison between the first user and the second user on one of the middle-tier model part and the upper-tier model part,
(B) selecting the second user through comparison between an output from the middle-tier model part for the first user and an output from the middle-tier model part for the second user,
(C) classifying the plurality of users into a plurality of middle-tier groups using an output from the middle-tier model part for each of the plurality of users, and selecting the second user from one of the plurality of middle-tier groups different from another one of the plurality of middle-tier groups to which the first user belongs, or
(D) presenting to the first user the middle-tier model parts or the upper-tier model parts for the others of the plurality of users so that the first user selects the middle-tier model part or the upper-tier model part from among the presented middle-tier model parts or upper-tier model parts, and selecting, as the second user, one of the others of the plurality of users corresponding to the middle-tier model part or upper-tier model part selected by the first user, and
the model generates the recommendation data to be outputted, by using one of the middle-tier model part or the upper-tier model part for the first user and the other of the middle-tier model part or the upper-tier model part for the second user.

10. The system according to claim 6, wherein
in response to the middle-tier data and the upper-tier data in relation to the lower-tier element being inputted by the first user, the model performs learning such that
the middle-tier data on the first user is reflected in the middle-tier model part for the first user, and
the upper-tier data on the first user is reflected in the upper-tier model part for the first user.

11. The system according to claim 6, wherein
the middle-tier model part is generated for each of the plurality of users, and is configured to generate an output in response to an input of lower-tier data relating to the lower-tier element such that the output reflects the middle-tier data on the first user, and
the upper-tier model part is generated for each of the plurality of users, and is configured to receive an input that is an output from the middle-tier model part, and to generate an output in response to the input such that the output reflects upper-tier data on the first user.

12. The system according to claim 11, wherein
the model is configured such that, in response to the middle-tier data and the upper-tier data for the lower-tier element being inputted by the first user,
a plurality of pieces of the lower-tier data are inputted to the middle-tier model part for the second user,
a plurality of outputs obtained from the middle-tier model part for the second user are inputted to the upper-tier model part for the first user,
a plurality of outputs obtained from the upper-tier model part for the first user are compared, and
by using a result of the comparison, the recommendation data to be outputted is generated.

13. A terminal for generating a recommendation to a first user based on an evaluation structure for a plurality of users, the evaluation structure being hierarchical and including a lower-tier element, a middle-tier element and an upper-tier element, the plurality of users including the first user and a second user, the terminal comprising:
an input section; and
an output section,
the input section being configured to receive at least intermediate-tier data inputted by each of the plurality of users, the intermediate-tier data relating to a middle-tier element, which is in association with the lower-tier element or the upper-tier element,
the output section being configured to, in response to the intermediate-tier data being inputted by the first user, generate output data in accordance with the input of the intermediate-tier data, the output data including recommendation data obtained through a model external to the terminal,
the model being configured to acquire the intermediate-tier data on each of the plurality of users, and to generate the recommendation data for generating the recommendation to the first user based on the acquired intermediate-tier data such that:
as the acquired intermediate-tier data of the first user changes, the recommendation data changes, or
even if the acquired intermediate-tier data of the first user is unchanged, the recommendation data changes.

14. The terminal according to claim 13, wherein
the intermediate-tier data includes:
middle-tier data relating to the middle-tier element, which is inputted in association with the lower-tier element, and
upper-tier data relating to the upper-tier element, which is inputted in association with the middle-tier element;
the output section is configured to, in response to the middle-tier data and the upper-tier data in relation to the lower-tier element being inputted by the first user, generate the output data in accordance with the middle-tier data and the upper-tier data;
the model is a proposal output generation model configured to, in response to the middle-tier data and the upper-tier data in relation to the lower-tier element being inputted by the first user, output the recommendation data in accordance with the middle-tier data and the upper-tier data;
the lower-tier element is a first lower-tier element, and the evaluation structure further includes a second lower-tier element different from the first lower-tier element; and
the recommendation data is data relating to the second lower-tier element.

15. The terminal according to claim 14, wherein
the model is configured to output the recommendation data that reflects the middle-tier data of the second user.

16. The terminal according to claim 14, wherein
the output data further includes involvement data, and
the involvement data is data for informing the first user that the second user is involved in selection of the second lower-tier element.

17. An application program configured to generate a recommendation to a first user based on an evaluation structure for a plurality of users, the evaluation structure being hierarchical and including a lower-tier element, a middle-tier element and an upper-tier element, the plurality of users including the first user and a second user, the application program causing a terminal to execute a process of:
receiving input data; and
outputting of output data in accordance with reception of the input data, wherein
the receiving of the input data is reception of the input data that includes intermediate-tier data, which is data relating to the middle-tier element in association with the lower-tier element or the upper-tier element,
the outputting of the output data includes, in response to the intermediate-tier data being inputted by the first user, outputting the output data including recommendation data obtained through a model external to the terminal, and
the model is configured to acquire the intermediate-tier data on each of the plurality of users, and to generate the recommendation data for generating the recommendation to the first user based on the acquired intermediate-tier data such that:
as the acquired intermediate-tier data on the first user changes, the recommendation data changes, or
even if the acquired intermediate-tier data on the first user is unchanged, the recommendation data changes.

18. The application program according to claim 17, wherein
the intermediate-tier data includes:
middle-tier data relating to the middle-tier element, which is inputted in association with the lower-tier element, and
upper-tier data relating to the upper-tier element, which is inputted in association with the middle-tier element;
the outputting of the output data includes, in response to the middle-tier data and the upper-tier data for the lower-tier element being inputted by the first user, outputting the output data including the recommendation data obtained through the model external to the terminal;
the model is a proposal output generation model configured to, in response to the middle-tier data and the upper-tier data for the lower-tier element being inputted by the first user, output the recommendation data in accordance with the middle-tier data and the upper-tier data;
the lower-tier element is a first lower-tier element, and the evaluation structure further includes a second lower-tier element different from the first lower-tier element; and
the recommendation data is data relating to the second lower-tier element.

19. The application program according to claim 18, wherein
the model is configured to output the recommendation data that reflects the middle-tier data of the second user.

20. The application program according to claim 18, wherein
the output data further includes involvement data, and
the involvement data is data for informing the first user that second user is involved in selection of the second lower-tier element.

21. A method performed by a terminal, for generating a recommendation to a first user based on an evaluation structure for a plurality of users, the evaluation structure being hierarchical and including a lower-tier element, a middle-tier element and an upper-tier element, the plurality of users including the first user and a second user, the method comprising:
receiving input data; and
outputting output data in accordance with reception of the input data, wherein
the receiving of the input data is reception of the input data that includes intermediate-tier data, which is data relating to the middle-tier element in association with the lower-tier element or the upper-tier element,
the outputting of the output data includes, in response to the intermediate-tier data being inputted by the first user, outputting the output data including recommendation data obtained through a model external to the terminal, and
the model is configured to acquire the intermediate-tier data on each of the plurality of users, and to generate the recommendation data for generating the recommendation to the first user based on the acquired intermediate-tier data such that:
as the acquired intermediate-tier data on the first user changes, the recommendation data changes, or
even if the acquired intermediate-tier data on the first user is unchanged, the recommendation data changes.

22. The method according to claim 21, wherein
the intermediate-tier data includes:
middle-tier data relating to the middle-tier element, which is inputted in association with the lower-tier element, and
upper-tier data relating to the upper-tier element, which is inputted in association with the middle-tier element;
the outputting of the output data includes, in response to the middle-tier data and the upper-tier data for the lower-tier element being inputted by the first user, outputting the output data including the recommendation data obtained through the model external to the terminal,
the model is a proposal output generation model configured to, in response to the middle-tier data and the upper-tier data for the lower-tier element being inputted by the first user, output the recommendation data in accordance with the middle-tier data and the upper-tier data;
the lower-tier element is a first lower-tier element, and the evaluation structure further includes a second lower-tier element different from the first lower-tier element; and
the recommendation data is data relating to the second lower-tier element.

23. The method according to claim 22, wherein
the model is configured to output the recommendation data that reflects the middle-tier data of the second user.

24. The method according to claim 22, wherein
the output data further includes involvement data, and
the involvement data is data for informing the first user that the second user is involved in selection of the second lower-tier element.
